(19) United States
(12) Patent Application Publication
(10) Pub. No.: US 2020/0201342 A1
(43) Pub. Date: Jun. 25, 2020

(54) OBSTACLE AVOIDANCE MODEL GENERATION METHOD, OBSTACLE AVOIDANCE MODEL GENERATION DEVICE, AND OBSTACLE AVOIDANCE MODEL GENERATION PROGRAM

(71) Applicant: AISIN SEIKI KABUSHIKI KAISHA, Kariya-shi (JP)

(72) Inventors: Yuta MIZUNO, Kariya-shi (JP); Ryuji SAIIN, Kariya-shi (JP)

(73) Assignee: AISIN SEIKI KABUSHIKI KAISHA, Kariya-shi (JP)

(21) Appl. No.: 16/711,528

(22) Filed: Dec. 12, 2019

(30) Foreign Application Priority Data
Dec. 13, 2018 (JP) 2018-233805

(51) Int. Cl. G05D 1/02; G08G 1/16; G06N 20/00; G06N 5/04

(52) U.S. Cl. CPC G05D 1/0214; G08G 1/16; G06N 5/04; G06N 20/00; G05D 1/0221

(57) ABSTRACT

An obstacle avoidance model generation method includes: acquiring surrounding information, at a determination point where a moving vehicle traveling in a space in which an obstacle is disposed determines a traveling direction, for each traveling direction of the moving vehicle, the surrounding information including a distance to the obstacle, a degree of coincidence in a direction toward a target point, and a degree of coincidence in a direction of the moving vehicle before and after determination of the traveling direction; determining the traveling direction on the basis of an obstacle avoidance model executing convolution processing of applying a filter to a region including the traveling directions in the surrounding information; causing the moving vehicle to travel in the traveling direction determined in the determining; and causing the obstacle avoidance model to learn how to select the traveling direction on the basis of a score obtained by repeating the determining of the traveling direction and the traveling of the moving vehicle.

### CROSS REFERENCE TO RELATED APPLICATIONS

This application is based on and claims priority under 35 U.S.C. § 119 to Japanese Patent Application 2018-233805, filed on Dec. 13, 2018, the entire contents of which are incorporated herein by reference.

### TECHNICAL FIELD

Embodiments of this disclosure relate to an obstacle avoidance model generation method, an obstacle avoidance model generation device, and an obstacle avoidance model generation program.

### BACKGROUND DISCUSSION

In the related art, a method of causing an obstacle avoidance model to learn an obstacle avoidance method through machine learning in a moving vehicle, which travels so as to avoid an obstacle, is known.

JP 2018-106466A is an example of the related art.

However, although the above-mentioned technique describes the case of Q learning, the output value of the control model, that is, the behavior of the control model becomes discrete in the Q learning, and it is difficult to avoid obstacles through smooth control. On the other hand, by increasing the resolution for determining the traveling direction, a measure for avoiding an obstacle through smooth control can be considered. However, in such a case, since the obstacle avoidance model must gain experience for each traveling direction, it takes a lot of learning time.

Thus, a need exists for an obstacle avoidance model generation method, an obstacle avoidance model generation device, and an obstacle avoidance model generation program which are not susceptible to the drawback mentioned above.

### SUMMARY

An obstacle avoidance model generation method according to an aspect of this disclosure includes, for example: acquiring surrounding information, at a determination point where a moving vehicle traveling in a space in which an obstacle is disposed determines a traveling direction, for each traveling direction of the moving vehicle, the surrounding information including a distance to the obstacle, a degree of coincidence in a direction toward a target point, and a degree of coincidence in a direction of the moving vehicle before and after determination of the traveling direction; determining the traveling direction of the moving vehicle, on the basis of an obstacle avoidance model that executes convolution processing of applying a filter to a region including a plurality of the traveling directions in the surrounding information acquired in the acquiring of the surrounding information; causing the moving vehicle to travel in the traveling direction determined in the determining of the traveling direction; and causing the obstacle avoidance model to learn how to select the traveling direction of the moving vehicle on the basis of a score obtained by repeating the determining of the traveling direction by determining of the traveling direction and the traveling of the moving vehicle by the causing the moving vehicle to travel. Therefore, for example, even in a case where the resolution in the traveling direction is increased, an increase in amount of learning can be suppressed.

An obstacle avoidance model generation device according to another aspect of this disclosure includes, for example: an acquisition unit that acquires surrounding information, at a determination point where a moving vehicle traveling in a space in which an obstacle is disposed determines a traveling direction, for each traveling direction of the moving vehicle, the surrounding information including a distance to the obstacle, a degree of coincidence in a direction toward a target point, and a degree of coincidence in a direction of the moving vehicle before and after determination of the traveling direction; a determination unit that determines the traveling direction of the moving vehicle, on the basis of an obstacle avoidance model that executes convolution processing of applying a filter to a region including a plurality of the traveling directions in the surrounding information acquired by the acquisition unit; a traveling unit that causes the moving vehicle to travel in the traveling direction determined by the determination unit; and a learning unit that causes the obstacle avoidance model to learn how to select the traveling direction of the moving vehicle on the basis of a score obtained by repeating the determining of the traveling direction performed by the determination unit and the traveling of the moving vehicle performed by the traveling unit.

A computer-readable medium storing an obstacle avoidance model generation program according to an aspect of this disclosure causes a computer to function as, for example: an acquisition unit that acquires surrounding information, at a determination point where a moving vehicle traveling in a space in which an obstacle is disposed determines a traveling direction, for each traveling direction of the moving vehicle, the surrounding information including a distance to the obstacle, a degree of coincidence in a direction toward a target point, and a degree of coincidence in a direction of the moving vehicle before and after determination of the traveling direction; a determination unit that determines the traveling direction of the moving vehicle, on the basis of an obstacle avoidance model that executes convolution processing of applying a filter to a region including a plurality of the traveling directions in the surrounding information acquired by the acquisition unit; a traveling unit that causes the moving vehicle to travel in the traveling direction determined by the determination unit; and a learning unit that causes the obstacle avoidance model to learn how to select the traveling direction of the moving vehicle on the basis of a score obtained by repeating the determining of the traveling direction performed by the determination unit and the traveling of the moving vehicle performed by the traveling unit.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a configuration diagram showing an example of a model generation device according to a first embodiment;

FIG. 2 is a block diagram exemplarily showing functions of the model generation device according to the first embodiment;

FIG. 3 is an explanatory diagram showing an outline of simulation executed by the model generation device according to the first embodiment;

FIG. 4 is an explanatory diagram showing an example of input and output of an obstacle avoidance model generated by the model generation device according to the first embodiment;

FIG. 5 is an explanatory diagram showing an example in which input and output information of the obstacle avoidance model generated by the model generation device according to the first embodiment is expressed in a one-dimensional array;

FIG. 6 is an explanatory diagram showing an example of a method of deriving sub-goal values at both ends of the one-dimensional array using the obstacle avoidance model generated by the model generation device according to the first embodiment;

FIG. 7 is an exemplary schematic flowchart showing reinforcement learning processing executed by the model generation device according to the first embodiment;

FIG. 8 is a flowchart showing an example of iterative learning processing executed by the model generation device according to the first embodiment;

FIG. 9 is a diagram showing a specific example of the iterative learning processing executed by the model generation device according to the first embodiment; and

FIG. 10 is an explanatory diagram showing an example of an input and output of the obstacle avoidance model generated by the model generation device according to Modification Example 1.

### DETAILED DESCRIPTION

Hereinafter, embodiments will be described with reference to the drawings. The configuration of the embodiment described below and the operations, results, and effects brought by the configuration are just examples, and are not limited to the following description.

### First Embodiment

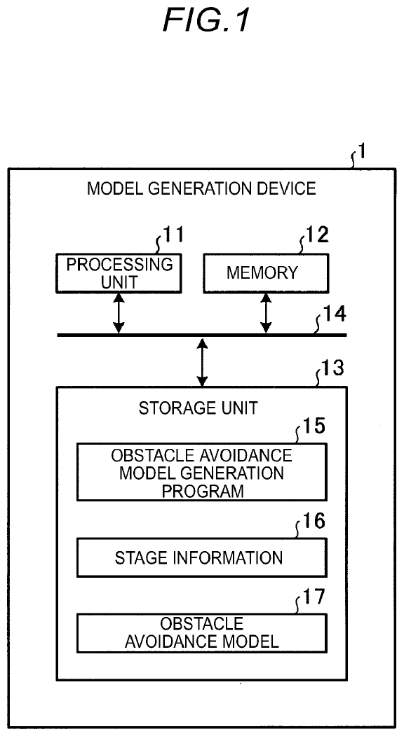

FIG. 1 is a configuration diagram showing an example of a model generation device 1 according to the first embodiment. The model generation device 1 generates an obstacle avoidance model 17. More specifically, the model generation device 1 causes the obstacle avoidance model 17 to perform learning by executing a simulation in which a moving vehicle travels in a space in which an obstacle is set.

The model generation device 1 is, for example, an information processing device such as a computer. The model generation device 1 includes a processing unit 11, a memory 12, a storage unit 13, and a bus 14.

The processing unit 11 is a hardware processor such as a central processing unit (CPU). The processing unit 11 executes various kinds of processing by reading a program stored in the memory 12 or the storage unit 13. For example, the processing unit 11 reads an obstacle avoidance model generation program 15 and executes a simulation for causing the moving vehicle to travel on the stage on which the obstacle is set. Accordingly, the processing unit 11 causes the obstacle avoidance model 17 to experience traveling in the space where the obstacle is set.

The memory 12 is a main storage device such as a read only memory (ROM) or a random access memory (RAM). The memory 12 stores data used by the processing unit 11 in a case of executing a program such as the obstacle avoidance model generation program 15.

The storage unit 13 is an auxiliary storage device such as a solid state drive (SSD) or a hard disk drive (HDD). For example, the storage unit 13 stores the obstacle avoidance model generation program 15, stage information 16, and the obstacle avoidance model 17.

The obstacle avoidance model generation program 15 is a program that generates the obstacle avoidance model 17 through machine learning. The stage information 16 is various information relating to a simulation stage on which the moving vehicle is caused to travel. For example, the stage information 16 includes information indicating a position where an obstacle is set. The obstacle avoidance model 17 is a learned model generated through machine learning.

The bus 14 connects the processing unit 11, the memory 12, and the storage unit 13 such that information can be transmitted and received among the units.

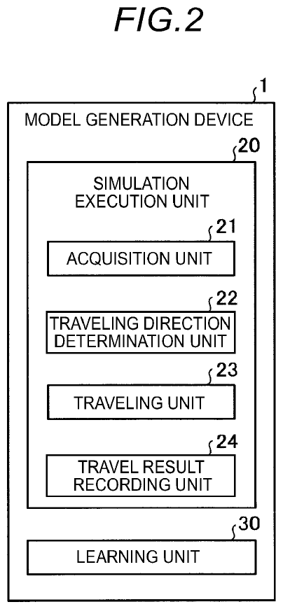

FIG. 2 is a block diagram exemplarily showing functions of the model generation device 1 according to the first embodiment. The functions shown in FIG. 2 are realized by cooperation between software and hardware. That is, in the example shown in FIG. 2, the functions of the model generation device 1 are implemented as a result of reading and executing of a predetermined control program performed by the processing unit 11. The predetermined control program includes, for example, the obstacle avoidance model generation program 15 stored in the storage medium such as the memory 12 or the storage unit 13. In the embodiment, at least a part of the functions shown in FIG. 2 may be implemented by dedicated hardware (circuit).

As shown in FIG. 2, the model generation device 1 according to the embodiment includes a simulation execution unit 20 and a learning unit 30.

The simulation execution unit 20 executes a simulation for causing a moving vehicle to travel in a space where an obstacle is set. The simulation execution unit 20 includes an acquisition unit 21, a traveling direction determination unit 22, a traveling unit 23, and a travel result recording unit 24.

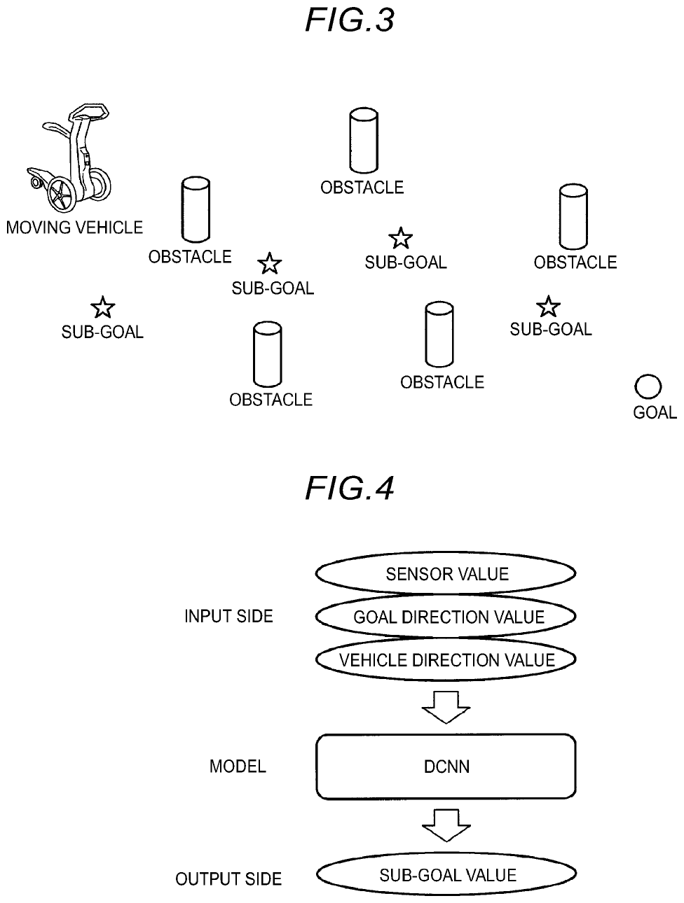

First, the outline of the simulation will be described. Here, FIG. 3 is an explanatory diagram for explaining the outline of the simulation executed by the model generation device 1 according to the first embodiment.

In the simulation, an obstacle placed in the space is caused to travel to the goal while estimating a route that can be avoided by the moving vehicle. Then, the moving vehicle travels to the goal by repeating the setting of the sub-goal and traveling to the sub-goal. The sub-goal is a goal that is temporarily set and indicates the traveling direction of the moving vehicle. In the simulation, obstacles are arranged at different positions for each stage.

Next, each unit included in the simulation execution unit 20 will be described.

The acquisition unit 21 acquires surrounding information, at a determination point where the moving vehicle traveling in the space in which the obstacle is disposed determines the traveling direction, for each traveling direction of the moving vehicle. The surrounding information includes a distance to the obstacle, a degree of coincidence in a direction toward a target point, and a degree of coincidence in the direction of the moving vehicle before and after determination of the traveling direction. More specifically, the acquisition unit 21 acquires a sensor value, a goal direction value, and a vehicle direction value, for each resolution in the traveling direction of the moving vehicle toward a start point or a sub-goal, with respect to 360 degrees around the moving vehicle. The sensor value indicates the distance to the obstacle. The goal direction value indicates the degree of coincidence of the direction toward the target point. The vehicle direction value indicates a degree of coincidence in the direction of the moving vehicle before and after determination of the traveling direction. It should be noted that the resolution in the traveling direction of the moving vehicle is optional, and may be, for example, 1 degree, 2 degrees or more, 0.5 degrees, 0.25 degrees, or 0.25 degrees or less.

The sensor value is a value which is output from a sensor that measures the distance to the obstacle. Here, it is assumed that the sensor is directed to the moving vehicle for each resolution in the traveling direction of the moving vehicle with respect to 360 degrees around the moving vehicle. That is, the sensor value is information indicating the distance from the moving vehicle to the obstacle.

The goal direction value is a value indicating the degree of coincidence in the direction of the moving vehicle toward the target point such as a goal. In the case of setting a sub-goal, the goal direction value is the highest value in a case where the front of the moving vehicle is directed to the goal, and is the lowest value in a case where the front of the moving vehicle is turned by 180 degrees in the opposite direction to the goal.

The vehicle direction value is information indicating the degree of coincidence in the direction of the moving vehicle before and after determination of the traveling direction. In a case of traveling toward the sub-goal, the vehicle direction value is the highest value in a case where the direction of the front of the moving vehicle is not changed, and is the lowest value in a case where the front of the moving vehicle is turned 180 degrees in the opposite direction.

The traveling direction determination unit 22 determines the traveling direction of the moving vehicle on the basis of the obstacle avoidance model 17 that executes convolution processing of applying a filter to a region including a plurality of traveling directions in the surrounding information acquired by the acquisition unit 21.

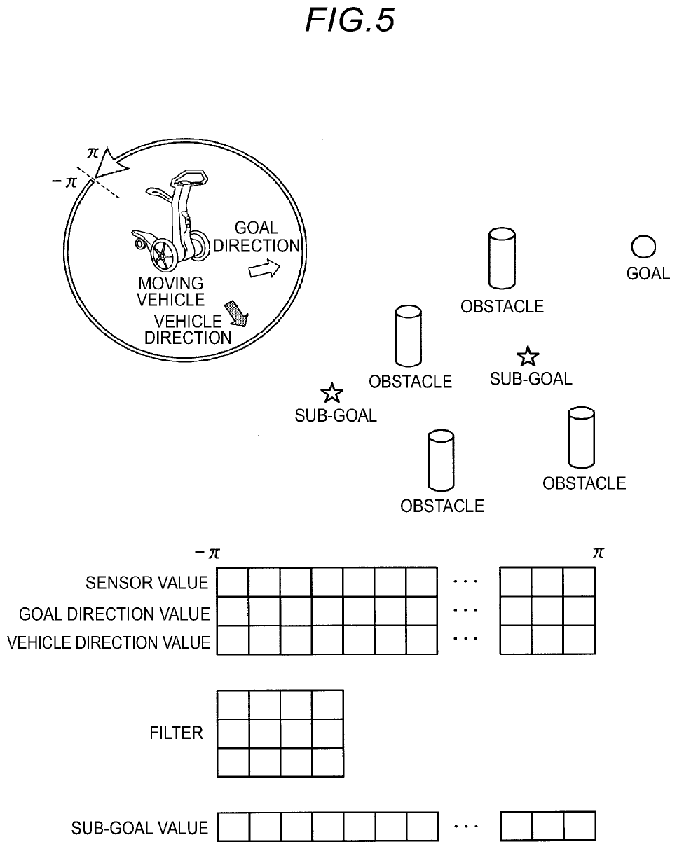

First, the obstacle avoidance model 17 will be described. FIG. 4 is an explanatory diagram showing an example of input and output of the obstacle avoidance model 17 generated by the model generation device 1 according to the first embodiment. FIG. 5 is an explanatory diagram showing an example in a case where the input and output information of the obstacle avoidance model 17 generated by the model generation device 1 according to the first embodiment is expressed in a one-dimensional array.

As shown in FIG. 4, the obstacle avoidance model 17 is formed by a deep convolutional neural network (DCNN) that executes convolution processing by applying a filter to a region in a predetermined range. The obstacle avoidance model 17 outputs a sub-goal value for each resolution in the traveling direction of the moving vehicle in a case where the sensor value, the goal direction value, and the vehicle direction value are input. The sub-goal value is a value necessary for setting a sub-goal in the corresponding traveling direction. Then, the traveling direction determination unit 22 sets a sub-goal in the traveling direction having the highest sub-goal value.

Here, as shown in FIG. 5, the acquisition unit 21 stores the sensor value, the goal direction value, and the vehicle direction value, for example, in a one-dimensional array for each resolution. For example, the acquisition unit 21 stores the sensor value, the goal direction value, and the vehicle direction value in the corresponding direction in the one-dimensional array for each degree of 360 degrees around the moving vehicle. Then, the obstacle avoidance model 17 derives the sub-goal value using the sensor value, the goal direction value, and the vehicle direction value in the corresponding direction.

That is, the obstacle avoidance model 17 executes convolution operation processing by applying the filter to the region including the plurality of traveling directions among the sensor value, the goal direction value, and the vehicle direction value for each traveling direction acquired by the acquisition unit 21. Then, the obstacle avoidance model 17 outputs the feature amount of the region to which the filter is applied by the convolution operation processing. The obstacle avoidance model 17 slides the position to which the filter is applied and executes the convolution operation processing again. The obstacle avoidance model 17 executes the convolution operation processing for all the 360 degrees around the moving vehicle by repeatedly executing this processing, and outputs the feature amount of each region.

The obstacle avoidance model 17 executes the convolution operation processing on 360 degrees around the moving vehicle by using a filter applied to a certain region. The obstacle avoidance model 17 sets a value obtained by executing such convolution operation processing as a sub-goal value.

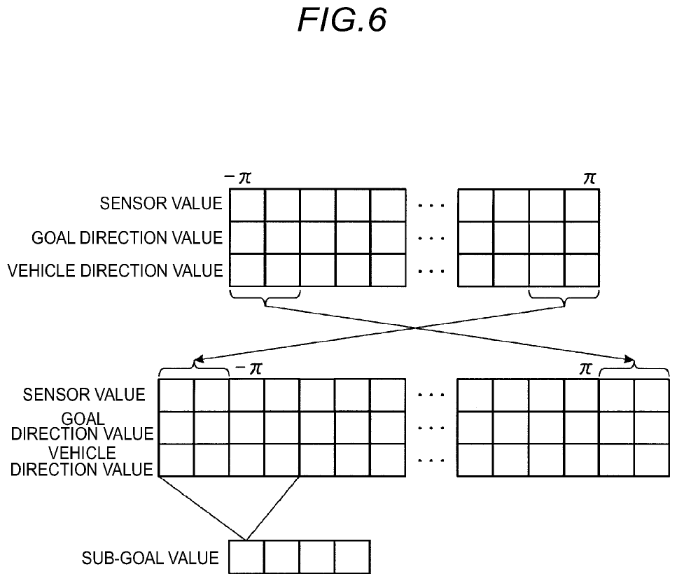

Next, a method of deriving the sub-goal values at both ends of the one-dimensional array will be described. Here, FIG. 6 is an explanatory diagram showing an example of a method of deriving the sub-goal values at both ends of the one-dimensional array by the obstacle avoidance model 17 generated by the model generation device 1 according to the first embodiment.

The acquisition unit 21 acquires the sensor value, the goal direction value, and the vehicle direction value from a region ranging from 0 degrees (π) to 360 degrees (−π). In a case where the obstacle avoidance model 17 derives the sub-goal value, the obstacle avoidance model 17 executes convolution processing of applying the filter to surrounding information including the angle in the corresponding traveling direction. Therefore, the obstacle avoidance model 17 is unable to calculate an accurate sub-goal value only with values after that at 0 degree in a case of calculating a sub-goal value near 0 degree. Therefore, as shown in FIG. 6, the sub-goal value is calculated using values before that at 360 degrees. That is, in a case where the surrounding information is stored in the one-dimensional array for each traveling direction in the order of the angles of the traveling directions, the traveling direction determination unit 22 determines the traveling direction of the moving vehicle on the basis of the obstacle avoidance model 17 that executes the convolution processing by applying a filter to a region including the start point and the end point of the one-dimensional array.

Returning to FIG. 2, the traveling unit 23 causes the moving vehicle to travel in the traveling direction determined by the traveling direction determination unit 22.

The travel result recording unit 24 records the travel result of the moving vehicle through simulation. More specifically, the travel result recording unit 24 records the sensor values, the goal direction values, and the vehicle direction values acquired by the acquisition unit 21 at the start point and the sub-goal points. In addition, the travel result recording unit 24 records the sub-goal values which are output by the obstacle avoidance model 17 at the start point and the sub-goal points. Further, the travel result recording unit 24 records a score obtained by traveling in a space where an obstacle is set. Here, the score is defined to include, for example, the time taken for traveling on the stage and the like.

The learning unit 30 causes the obstacle avoidance model 17 to learn how to select the traveling direction of the moving vehicle on the basis of the score obtained by repeating the determination of the traveling direction performed by the traveling direction determination unit 22 and the traveling of the moving vehicle performed by the traveling unit 23. More specifically, the learning unit 30 inputs a score, which is obtained in a case where the moving vehicle travels in the space where the obstacle is set, to the obstacle avoidance model 17. The obstacle avoidance model 17 evaluates the method of deriving the sub-goal values at the start point and the sub-goal points on the basis of the input score. For example, in a case where it is evaluated that an inappropriate sub-goal value in a certain traveling direction at a certain sub-goal point is derived, in the same state, the obstacle avoidance model 17 changes the method of deriving the sub-goal values such that the sub-goal values in the traveling directions of the surrounding including the corresponding traveling direction become low.

If the obstacle avoidance model 17 does not execute the convolution processing, the respective pieces of information acquired by the acquisition unit 21 correspond one-to-one with the sub-goal values. In such a case, the obstacle avoidance model 17 changes the derivation method such that the sub-goal value in the corresponding traveling direction becomes low, but does not change the derivation method such that the sub-goal value in the traveling direction adjacent to the corresponding traveling direction becomes low. Therefore, in a case where the convolution processing is not executed, it is necessary for the obstacle avoidance model 17 to experience all the traveling directions in order to be able to derive an appropriate sub-goal value. Therefore, as the resolution in the traveling direction becomes higher, the amount of learning necessary for the obstacle avoidance model 17 to have experience increases dramatically.

The obstacle avoidance model 17 according to the present embodiment changes the method of deriving the sub-goal values such that the sub-goal values in the traveling directions of the surrounding including the corresponding traveling direction become low by executing the convolution processing. Therefore, the obstacle avoidance model 17 according to the present embodiment is able to suppress an increase in amount of learning necessary for learning.

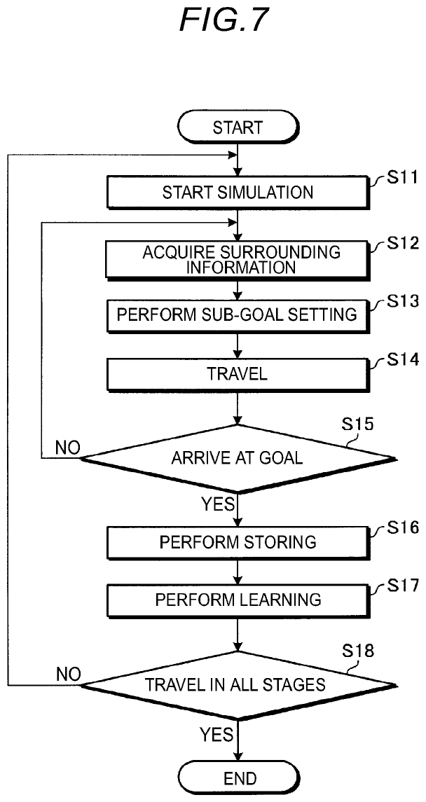

Next, a procedure for performing reinforcement learning on the obstacle avoidance model 17 will be described. FIG. 7 is an exemplary and schematic flowchart showing the reinforcement learning processing executed by the model generation device 1 according to the first embodiment.

The simulation execution unit 20 reads the stage information 16 of the stage to be executed and starts a simulation (S11).

The acquisition unit 21 acquires surrounding information of the moving vehicle (S12). That is, the acquisition unit 21 acquires a sensor value, a goal direction value, and a vehicle direction value.

The traveling direction determination unit 22 determines the traveling direction of the moving vehicle on the basis of the obstacle avoidance model 17 (S13). That is, the traveling direction determination unit 22 sets a sub-goal on the basis of the sub-goal value which is output by the obstacle avoidance model 17 for each traveling direction.

The traveling unit 23 causes the moving vehicle to travel in the traveling direction determined by the traveling direction determination unit 22 (S14). That is, the traveling unit 23 causes the moving vehicle to travel to the sub-goal determined by the traveling direction determination unit 22.

The acquisition unit 21 determines whether or not the moving vehicle arrives at the goal of the stage (S15). If the moving vehicle does not arrive at the goal (No in S15), the acquisition unit 21 acquires surrounding information of the moving vehicle in S12.

In contrast, if the moving vehicle arrives at the goal (Yes in S15), the travel result recording unit 24 stores the travel result of the simulation in the storage unit 13 (S16).

The learning unit 30 causes the obstacle avoidance model 17 to learn how to select the traveling direction of the moving vehicle using the travel result stored in the storage unit 13 (S17).

The simulation execution unit 20 determines whether traveling of all stages scheduled to be executed is completed (S18). If the traveling of all the stages is not completed (No in S18), the simulation execution unit 20 starts the simulation of the stage on which the traveling is not yet performed in S11.

In contrast, if the traveling of all the stages is completed (No in S18), the model generation device 1 ends the reinforcement learning processing.

Next, the iterative learning processing will be described.

In the iterative learning processing, in a case of traveling in the same space through the plurality of obstacle avoidance models 17, the learning unit 30 performs learning of the travel result having the highest score as an exemplary travel, thereby generating the obstacle avoidance model 17. Here, the travel result having the highest score is, for example, a travel result in which the time taken for traveling on the stage is short. In addition, the learning unit 30 generates the obstacle avoidance model 17 by learning the travel result having the highest score among the travel results including the travel result of traveling in the same space through the generated obstacle avoidance model 17. In such a manner, through the iterative learning processing, the obstacle avoidance model 17 capable of traveling with a higher score is generated by repeating generation of the obstacle avoidance model 17 and traveling thereof.

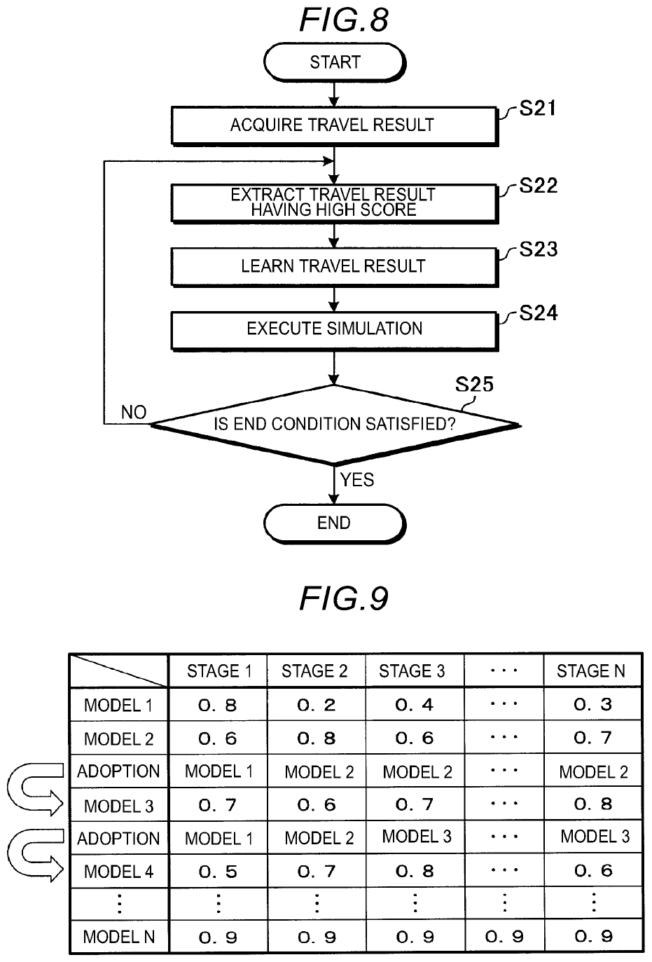

Here, FIG. 8 is a flowchart showing an example of the iterative learning processing executed by the model generation device 1 according to the first embodiment. FIG. 9 is a diagram showing a specific example of the iterative learning processing executed by the model generation device 1 according to the first embodiment.

The learning unit 30 acquires travel results obtained in a case where traveling on one or a plurality of stages is performed through the two or more obstacle avoidance models 17 (S21). In FIG. 9, the travel results of the stages are acquired by traveling from the course 1 to the course N through the model 1 and the model 2. For example, the model 1 is an obstacle avoidance model 17 generated through the machine learning described above. The model 2 is an obstacle avoidance model 17 generated through machine learning by the potential method.

The learning unit 30 extracts the travel result of the obstacle avoidance model 17 through which traveling with the best score is performed for each stage (S22). In FIG. 9, the learning unit 30 extracts the travel result of the model 1 from the travel results of the model 1 and the model 2 in the stage 1. The learning unit 30 extracts the travel result of the model 2 in the stage 2. The learning unit 30 extracts the travel result of the model 2 in the stage 3. The learning unit 30 extracts the travel result of the model 2 in the stage N.

The learning unit 30 causes the obstacle avoidance model 17 to learn the extracted travel result (S23). That is, the learning unit 30 inputs the sensor values, the goal direction values, and the vehicle direction values at the start point and the sub-goal points in each stage to the obstacle avoidance model 17 as learning data on the input side. The learning unit 30 inputs the sub-goal values, which correspond to the learning data on the input side in each stage, to the learning data on the output side and the obstacle avoidance model 17.

In FIG. 9, the learning unit 30 causes the obstacle avoidance model 17 to learn the travel result of the model 1 in the stage 1, learn the travel result of the model 2 in the stage 2, learn the travel result of the model 2 in the stage 3, and learn the travel result of the model 2 in the stage N. Thereby, the learning unit 30 generates the model 3.

The simulation execution unit 20 executes a simulation of traveling on each stage using the generated obstacle avoidance model 17 (S24). In FIG. 9, the travel result of each stage is acquired by traveling from the course 1 to the course N through the model 3 generated in step S3.

The learning unit 30 determines whether or not an end condition for the iterative learning processing is satisfied (S25). Here, regarding the end condition, for example, the score of the newly generated obstacle avoidance model 17 may be equal to or higher than a threshold value, and the score of the newly generated obstacle avoidance model 17 may be equal to or higher than the score of other obstacle avoidance model 17, or may be the number of iterative learning operations.

If the end condition is satisfied (No in S25), the learning unit 30 extracts the travel result having the best score including the travel result of the newly generated obstacle avoidance model 17 in S2.

In FIG. 9, it is determined that the end condition is not satisfied, and the learning unit 30 extracts the travel result of the obstacle avoidance model 17 having the best score among the travel results of the models 1 to 3 for each stage. The learning unit 30 causes the obstacle avoidance model 17 to learn the travel result having the best score in each stage. Thereby, the learning unit 30 generates the model 3. The learning unit 30 generates the model N by repeatedly executing these kinds of processing.

Then, in a case where the end condition is satisfied (Yes in S25), the model generation device 1 ends the iterative learning processing.

As described above, in the model generation device 1 according to the first embodiment, the obstacle avoidance model 17 derives a sub-goal value by executing convolution processing of applying the filter to a region including the plurality of traveling directions in the surrounding information acquired by the acquisition unit 21 in the traveling of each stage where the obstacle is placed. The moving vehicle travels in the traveling direction selected on the basis of the sub-goal values. Then, the obstacle avoidance model 17 evaluates the derivation method of the sub-goal values on the basis of the travel result of the moving vehicle, and changes the derivation method. As described above, the obstacle avoidance model 17 learns the derivation method of the sub-goal values for the feature amount of the region of the filter by executing the convolution processing. Therefore, the obstacle avoidance model 17 is able to suppress an increase in amount of learning even in a case where the resolution in the traveling direction is increased.

### Modification Example 1

The acquisition unit 21 according to the first embodiment acquires a distance to the obstacle, a degree of coincidence in a direction toward a target point, and a degree of coincidence in the direction of the moving vehicle before and after determination of the traveling direction, at a determination point where the moving vehicle traveling in the space in which the obstacle is disposed determines the traveling direction, for each traveling direction of the moving vehicle. Then, in the obstacle avoidance model 17, the sub-goal values are derived on the basis of these kinds of information. In addition to these kinds of information, the acquisition unit 21 according to Modification Example 1 acquires a previous direction value indicating a degree of change in direction of the moving vehicle before and after the moving vehicle travels in the traveling direction selected by the traveling direction determination unit 22 at the previous start point or sub-goal point. Then, in the obstacle avoidance model 17, the sub-goal values are derived on the basis of these kinds of information.

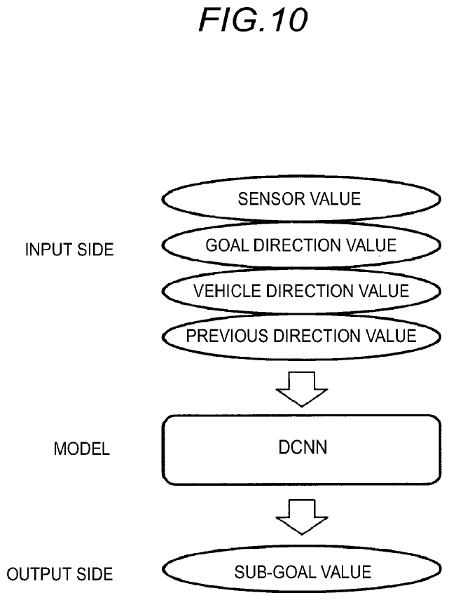

Here, FIG. 10 is an explanatory diagram showing an example of input and output of the obstacle avoidance model 17 generated by the model generation device 1 according to Modification Example 1. The previous direction value is input to the obstacle avoidance model 17 according to Modification Example 1, for each traveling direction of the moving vehicle, in addition to the sensor value, the goal direction value, and the vehicle direction value. The sensor value indicates the distance to the obstacle. The goal direction value indicates the degree of coincidence in the direction toward the target point. The vehicle direction value indicates the degree of coincidence in the direction of the moving vehicle before and after determination of the traveling direction. The obstacle avoidance model 17 outputs a sub-goal value for each resolution in the traveling direction of the moving vehicle in a case where the sensor value, the goal direction value, the vehicle direction value, and the previous direction value are input.

Thus, by inputting the degree of change in the direction of the moving vehicle at the previous start point or sub-goal point, the degree of change in the previous direction can be compared with the degree of change in the current direction. Therefore, for example, in a case where the current degree of change is larger than the previous degree of change, it is possible to learn whether the determination is appropriate.

An obstacle avoidance model generation method according to an aspect of this disclosure includes, for example: acquiring surrounding information, at a determination point where a moving vehicle traveling in a space in which an obstacle is disposed determines a traveling direction, for each traveling direction of the moving vehicle, the surrounding information including a distance to the obstacle, a degree of coincidence in a direction toward a target point, and a degree of coincidence in a direction of the moving vehicle before and after determination of the traveling direction; determining the traveling direction of the moving vehicle, on the basis of an obstacle avoidance model that executes convolution processing of applying a filter to a region including a plurality of the traveling directions in the surrounding information acquired in the acquiring of the surrounding information; causing the moving vehicle to travel in the traveling direction determined in the determining of the traveling direction; and causing the obstacle avoidance model to learn how to select the traveling direction of the moving vehicle on the basis of a score obtained by repeating the determining of the traveling direction by determining of the traveling direction and the traveling of the moving vehicle by the causing the moving vehicle to travel. Therefore, for example, even in a case where the resolution in the traveling direction is increased, an increase in amount of learning can be suppressed.

In the obstacle avoidance model generation method according to the aspect, the acquiring of the surrounding information may acquire a degree of change in direction of the moving vehicle before and after the moving vehicle travels in the traveling direction selected at the previous determination point in the determining of the traveling direction. Therefore, for example, the obstacle avoidance model that obtains a higher score can be generated using this degree of change.

In the obstacle avoidance model generation method according to the aspect, in the determining of the traveling direction, in a case where the surrounding information is stored in one-dimensional array for each of the travel directions in order of angles of the travel directions, the traveling direction of the moving vehicle may be determined on the basis of the obstacle avoidance model that executes the convolution processing by applying the filter to a region including a start point and an end point of the one-dimensional array. Therefore, for example, the traveling direction can be determined more accurately.

In the obstacle avoidance model generation method according to the aspect, in the learning of the obstacle avoidance model, in a case of traveling in the same space through a plurality of the obstacle avoidance models, the obstacle avoidance model may be generated through learning of a travel result having a highest score, and the obstacle avoidance model is generated through learning of the travel result having a highest score among the travel results including the travel result of traveling in the space through the generated obstacle avoidance model. Therefore, for example, an obstacle avoidance model that obtains a higher score can be generated.

An obstacle avoidance model generation device according to another aspect of this disclosure includes, for example: an acquisition unit that acquires surrounding information, at a determination point where a moving vehicle traveling in a space in which an obstacle is disposed determines a traveling direction, for each traveling direction of the moving vehicle, the surrounding information including a distance to the obstacle, a degree of coincidence in a direction toward a target point, and a degree of coincidence in a direction of the moving vehicle before and after determination of the traveling direction; a determination unit that determines the traveling direction of the moving vehicle, on the basis of an obstacle avoidance model that executes convolution processing of applying a filter to a region including a plurality of the traveling directions in the surrounding information acquired by the acquisition unit; a traveling unit that causes the moving vehicle to travel in the traveling direction determined by the determination unit; and a learning unit that causes the obstacle avoidance model to learn how to select the traveling direction of the moving vehicle on the basis of a score obtained by repeating the determining of the traveling direction performed by the determination unit and the traveling of the moving vehicle performed by the traveling unit. Therefore, for example, even in a case where the resolution in the traveling direction is increased, an increase in amount of learning can be suppressed.

A computer-readable medium storing an obstacle avoidance model generation program according to an aspect of this disclosure causes a computer to function as, for example: an acquisition unit that acquires surrounding information, at a determination point where a moving vehicle traveling in a space in which an obstacle is disposed determines a traveling direction, for each traveling direction of the moving vehicle, the surrounding information including a distance to the obstacle, a degree of coincidence in a direction toward a target point, and a degree of coincidence in a direction of the moving vehicle before and after determination of the traveling direction; a determination unit that determines the traveling direction of the moving vehicle, on the basis of an obstacle avoidance model that executes convolution processing of applying a filter to a region including a plurality of the traveling directions in the surrounding information acquired by the acquisition unit; a traveling unit that causes the moving vehicle to travel in the traveling direction determined by the determination unit; and a learning unit that causes the obstacle avoidance model to learn how to select the traveling direction of the moving vehicle on the basis of a score obtained by repeating the determining of the traveling direction performed by the determination unit and the traveling of the moving vehicle performed by the traveling unit. Therefore, for example, even in a case where the resolution in the traveling direction is increased, an increase in amount of learning can be suppressed.

Although the embodiment disclosed here has been hitherto exemplified, the embodiments and modification example are just examples, and do not limit the scope of the disclosure. The above-mentioned embodiments and modification examples can be implemented in various other forms, and various omissions, replacements, combinations, and changes can be made without departing from the scope of the disclosure. In addition, the configuration and shape of each embodiment and each modification example may be partially replaced.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. An obstacle avoidance model generation method comprising:
acquiring surrounding information, at a determination point where a moving vehicle traveling in a space in which an obstacle is disposed determines a traveling direction, for each traveling direction of the moving vehicle, the surrounding information including a distance to the obstacle, a degree of coincidence in a direction toward a target point, and a degree of coincidence in a direction of the moving vehicle before and after determination of the traveling direction;
determining the traveling direction of the moving vehicle, on the basis of an obstacle avoidance model that executes convolution processing of applying a filter to a region including a plurality of the traveling directions in the surrounding information acquired in the acquiring of the surrounding information;
causing the moving vehicle to travel in the traveling direction determined in the determining of the traveling direction; and
causing the obstacle avoidance model to learn how to select the traveling direction of the moving vehicle on the basis of a score obtained by repeating the determining of the traveling direction by determining of the traveling direction and the traveling of the moving vehicle by the causing the moving vehicle to travel.

2. The obstacle avoidance model generation method according to claim 1, wherein
the acquiring of the surrounding information acquires a degree of change in direction of the moving vehicle before and after the moving vehicle travels in the traveling direction selected at the previous determination point in the determining of the traveling direction.

3. The obstacle avoidance model generation method according to claim 1, wherein
in the determining of the traveling direction, in a case where the surrounding information is stored in one-dimensional array for each of the travel directions in order of angles of the travel directions, the traveling direction of the moving vehicle is determined on the basis of the obstacle avoidance model that executes the convolution processing by applying the filter to a region including a start point and an end point of the one-dimensional array.

4. The obstacle avoidance model generation method according to claim 1, wherein
in the learning of the obstacle avoidance model, in a case of traveling in the same space through a plurality of the obstacle avoidance models, the obstacle avoidance model is generated through learning of a travel result having a highest score, and the obstacle avoidance model is generated through learning of the travel result having a highest score among the travel results including the travel result of traveling in the space through the generated obstacle avoidance model.

5. An obstacle avoidance model generation device comprising:
an acquisition unit that acquires surrounding information, at a determination point where a moving vehicle traveling in a space in which an obstacle is disposed determines a traveling direction, for each traveling direction of the moving vehicle, the surrounding information including a distance to the obstacle, a degree of coincidence in a direction toward a target point, and a degree of coincidence in a direction of the moving vehicle before and after determination of the traveling direction;
a determination unit that determines the traveling direction of the moving vehicle, on the basis of an obstacle avoidance model that executes convolution processing of applying a filter to a region including a plurality of the traveling directions in the surrounding information acquired by the acquisition unit;
a traveling unit that causes the moving vehicle to travel in the traveling direction determined by the determination unit; and
a learning unit that causes the obstacle avoidance model to learn how to select the traveling direction of the moving vehicle on the basis of a score obtained by repeating the determining of the traveling direction performed by the determination unit and the traveling of the moving vehicle performed by the traveling unit.

6. A computer-readable medium storing an obstacle avoidance model generation program for causing a computer to function as:
an acquisition unit that acquires surrounding information, at a determination point where a moving vehicle traveling in a space in which an obstacle is disposed determines a traveling direction, for each traveling direction of the moving vehicle, the surrounding information including a distance to the obstacle, a degree of coincidence in a direction toward a target point, and a degree of coincidence in a direction of the moving vehicle before and after determination of the traveling direction;
a determination unit that determines the traveling direction of the moving vehicle, on the basis of an obstacle avoidance model that executes convolution processing of applying a filter to a region including a plurality of the traveling directions in the surrounding information acquired by the acquisition unit;
a traveling unit that causes the moving vehicle to travel in the traveling direction determined by the determination unit; and
a learning unit that causes the obstacle avoidance model to learn how to select the traveling direction of the moving vehicle on the basis of a score obtained by repeating the determining of the traveling direction performed by the determination unit and the traveling of the moving vehicle performed by the traveling unit.
